(19) United States
(12) Patent Application Publication
(10) Pub. No.: US 2026/0019548 A1
(43) Pub. Date: Jan. 15, 2026

(54) SENSOR SYSTEM

(71) Applicant: SICK AG, Waldkirch (DE)

(72) Inventors: Simone Bexten, Freiburg (DE); Tobias Bamberger, Freiburg (DE); Maximilian Lindinger, Waldkirch (DE); Patrick Junker, Zell a. H. (DE); Hellen Altendorf, Kirchzarten (DE); Florian Roser, Denzlingen (DE); Matthias Heinz, Waldkirch (DE); Stefan Werner, Paderborn (DE); Daniel Herb, Emmendingen (DE)

(21) Appl. No.: 19/266,370

(22) Filed: Jul. 11, 2025

(30) Foreign Application Priority Data
Jul. 12, 2024 (EP) 24188309.9

(51) Int. Cl. H04N 13/25; B60R 25/10; G06V 10/82; G06V 20/58; G08B 13/196; H04N 13/275

(52) U.S. Cl. CPC H04N 13/25; B60R 25/1012; G06V 10/82; G06V 20/58; G08B 13/19613; H04N 13/275

(57) ABSTRACT

A sensor system for monitoring a spatial region in an outdoor region or in an industrial plant, for example for use on a manned vehicle or an autonomously driving industrial truck, includes a sensor arrangement. The sensor system is configured to generate 2D and 3D data of the spatial region. In this respect, the sensor system has a computing device that is configured to perform a person detection method on the 2D data of the spatial region in order to recognize persons in the spatial region. 2D position data are determined for a recognized person. The computing device is furthermore configured, on the basis of the 2D position data for the recognized person, to assign 3D data associated with the recognized person. The computing device is further configured to determine 3D position data for the recognized person from the 3D data associated with the recognized person.

The present invention relates to a sensor system for monitoring a spatial region in an outdoor region or a spatial region in in an industrial plant, for example for use on a manned vehicle or an autonomously driving industrial truck, said sensor system comprising a sensor arrangement, wherein the sensor system or the sensor arrangement is configured to generate 3D data of the spatial region.

Sensor systems on vehicles in an outdoor region, e.g. on construction sites, in mines or in open-cast mining, can serve to avoid collisions with persons or objects and are known in principle. Sensor systems for monitoring spatial regions in industrial plants are also generally known. Such sensor systems are, for example, used to recognize the intrusion of a person into a protected region. When entering such a protected region, the industrial machine can then be slowed down or stopped in order not to endanger the person.

The recognition of persons and in particular the distinction between persons and other objects can be time-consuming, which can be disadvantageous in industrial plants in which, on the one hand, only limited computing power is available but, on the other hand, there are high demands on the evaluation speed. In this respect, it is in particular also challenging not only to recognize the person, but also to determine the location of the person in three-dimensional space.

It is therefore an underlying object of the invention to provide a sensor system that enables a fast and efficient recognition of persons in a spatial region.

This object is satisfied by a sensor system according to claim 1.

The sensor system according to the invention serves to monitor a spatial region in an outdoor region or in an industrial plant and in particular for use on a manned vehicle or an autonomously driving industrial truck. The sensor system comprises a sensor arrangement, for example a stereo camera, wherein the sensor system or the sensor arrangement is configured to generate 3D data of the spatial region, wherein the sensor system furthermore generates 2D data of the spatial region. The sensor system has a computing device that is configured to perform a person detection method, which is in particular based on artificial intelligence, on the 2D data of the spatial region in order to recognize persons in the spatial region, wherein 2D position data are determined for a recognized person. The computing device is preferably furthermore configured, on the basis of the 2D position data for the recognized person, to assign 3D data associated with the recognized person. Finally, the computing device is configured to determine 3D position data for the recognized person from the 3D data associated with the recognized person.

The 3D position data can indicate the position of the recognized person in three-dimensional space.

The invention is in this respect based on the realization that by performing the person detection method on the 2D data, an efficient yet reliable recognition of persons can be carried out. This is due to the fact that the 2D data are less extensive and thus easier to process than the 3D data that additionally contain depth information and distance information. According to the invention, the position of the person can therefore first be determined in the 2D data, wherein, on the basis of the position thus obtained, which is expressed by the 2D position data, the associated data points are then determined in the 3D data. The three-dimensional position of the person can then be determined from the 3D data. The three-dimensional position of the person is then represented by the 3D position data.

Due to the method according to the invention, computing power can in particular be saved during the initial recognition and detection of the person so that the sensor system according to the invention is generally suitable for industrial applications and in particular for mobile industrial applications.

Due to the efficient person detection, the sensor system can be configured for a person recognition in real time. For example, a person recognition can take less than 100 ms or less than 70 ms.

Further details of the invention will be described in the following.

The spatial region can, for example, be that three-dimensional region of the industrial plant that can be detected by the sensor arrangement. The sensor arrangement can comprise one or more sensors. For example, the sensor arrangement can have a stereo camera for a three-dimensional detection of the spatial region. Alternatively or in addition to the stereo camera, other sensor types are also possible, such as 3D TOF (Time-of-Flight) cameras, LIDAR (Light Detection and Ranging) systems, laser scanners and the like. The sensor arrangement can generally also comprise a 2D camera that, for example, generates an RGB image or intensity image or grayscale image, wherein the RGB image or grayscale image can then be used as 2D data.

The computing device can in particular be a processor, for example, a CPU or GPU. The computing device can also have additional processors, as will be explained later.

The person detection method serves to recognize whether and where at least one person is present in the spatial region. The person detection method can be purely algorithmic, but is preferably in particular based on artificial intelligence. Artificial intelligence is herein generally to be understood as a method that uses machine learning algorithms, neural networks or the like.

As already indicated, the 2D data can in particular in each case comprise data for two dimensions, i.e. represent a two-dimensional image, for example. The 3D data preferably additionally also comprise distance data, i.e. a third dimension. The distance data can be measured from the sensor arrangement, for example. The 2D data and in particular the 3D data can each be present as a point cloud.

For example, the 3D data can be converted into the 2D data by a projection onto a two-dimensional plane. In this way, a correspondence between 2D data and 3D data can be established.

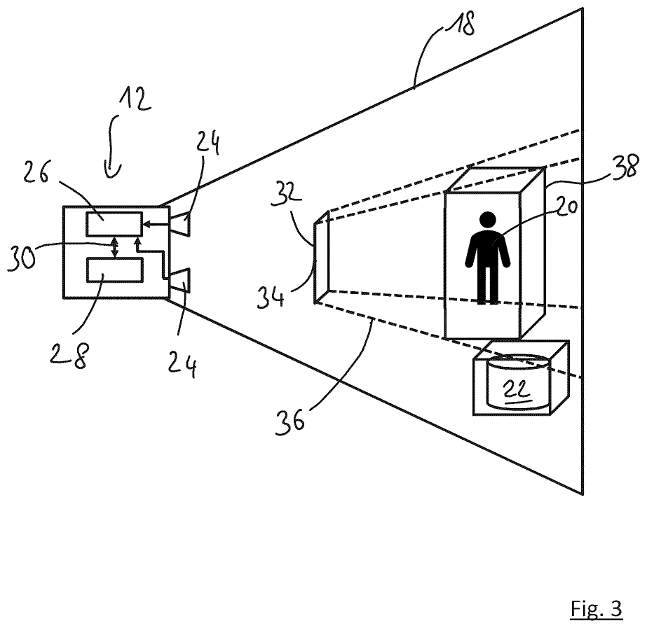

The 2D data are preferably fed to the person detection method so that the person detection method can recognize in the 2D data a person that is possibly present there. The person detection method can then return the 2D position data that indicate where the person was recognized in the 2D data. This can be a 2D position region, i.e., for example, a bounding box, as will be explained in more detail later. Once the two-dimensional position or the two-dimensional position region is known, the 3D data associated with the 2D position data can be determined. In particular, those data points of the point cloud that correspond to the 2D position data can be used as the associated 3D data, as later also shown in FIG. 3. In other words, the associated 3D data can be projected onto the 2D position data.

As will likewise be explained in more detail later, from the 3D data determined in this way, the 3D data actually belonging to the person can be determined, from which 3D position data for the recognized person then result. In this way, the three-dimensional position of the person in space can be determined.

Advantageous further developments of the invention can be seen from the description, from the drawings and from the dependent claims.

According to a first embodiment, the computing device is configured to use only the 2D data for the person detection method for determining the 2D position data. Preferably, the 3D data are therefore not used for the person detection method, whereby the person detection is simplified, less memory is required and a smaller computing effort is caused. In this way, the implementation in a mobile sensor system can be made more efficient.

According to a further embodiment, the sensor system, and in particular the computing device, is configured to generate the 2D data from the 3D data. The sensor arrangement can thus have a dual function and can generate the 3D data and the 2D data at the same time. Hardware requirements are thus reduced since an additional two-dimensional camera can be dispensed with. In a stereo camera, the generation of the 2D data can, for example, be realized in that at least one of the two image sensors functions as a 2D image sensor.

According to a further embodiment, the person detection method comprises using an artificial intelligence, in particular an artificial neural network, preferably a convolutional neural network, CNN. Such an artificial intelligence and in particular the CNN are suitable for detecting persons in images since the artificial intelligence can be trained with a large number of images of persons in different poses, clothing and lighting conditions, whereby a reliable recognition is made possible.

For example, labeled data can be used for the training of the artificial intelligence and in particular of the neural network. Due to the label, it can be known whether and at what position a person can be seen in a respective image of the data set. Examples of such data sets of labeled images that could be used in the present case are MS-COCO, Objekts365, OpenimagesV7, SODA and the like. The training of the artificial intelligence can in particular take place as so-called “supervised learning”. During the training, images from the data set are fed to the artificial intelligence in each case, wherein the artificial intelligence then determines for each image whether and at what position a person can be seen in the image. If the results of the artificial intelligence deviate from the data stored for the respective image, in the case of, for example, a neural network, the weights and/or preloads used there are adjusted. The adjustment of the weights as well as the alternative or additional adjustment of the preload within the neural network in this respect take place with the aim of minimizing a predefined function, the so-called loss function. In other words, a function approximation is performed by minimizing the deviation from a target function. The training of the artificial intelligence can take place on a computing device other than the computing device of the sensor system. After the training, the fully trained artificial intelligence is then transferred to the computing device of the sensor system.

In particular, a neural network comprising a plurality of layers can be used for the neural network. For example, a neural network comprising at least 20, 40 or 60 layers can be used. A so-called YOLO network (You Only Look Once) can be used as an example, in particular the YOLOX Large Leaky network. For example, the artificial neural network can comprise more than 20 million, more than 40 million or more than 50 million parameters.

In particular, an input layer of the artificial neural network can have a number of neurons that corresponds at least to the number of pixels of the images contained in the 2D data (in a single frame).

According to a further embodiment, the artificial intelligence has been trained at least partly (or completely) with 2D data in the form of images, wherein preferably the resolution, i.e. the number of pixels, of the images differs less than 30%, preferably less than 20%, further preferably 0%, from the resolution of the 2D data obtained (during operation) by the person detection method. For example, the images contained in the above-mentioned image libraries can be scaled and/or downscaled such that their resolution corresponds to the resolution of the 2D data obtained during operation by the person detection method. In this way, the artificial intelligence can be ideally trained on the data obtained during operation so that, for example, persons can still be correctly recognized even at a range limit of the sensor arrangement.

According to a further embodiment, the sensor system is configured to provide three-dimensional protective fields and/or warning fields within the spatial region, wherein a violation of a protective field and/or warning field takes place based on the 3D position data, wherein a warning signal is output, in particular by the sensor system, in the event of a violation of a protective field and/or warning field by a recognized person. The protective fields and/or warning fields can have a two-dimensional or three-dimensional shape. A three-dimensional protective field and/or warning field can be referred to as a volume of interest (Vol). In this respect, due to the knowledge of the three-dimensional position of the person (i.e. due to the 3D position data), it is advantageously possible to determine whether the person is actually in the protective field or warning field or whether the person is still behind the protective field or warning field, for example. After receiving the warning signal, an autonomous vehicle can then, for example, slow down its travel, stop or drive around the recognized person at a safe distance.

The sensor system can in particular comprise a field configuration device with which the field limits of protective fields and/or warning fields can be set or adjusted. Protective fields can in this respect be monitored for unauthorized intrusions, wherein, in the event of such an intrusion, in particular a safety-related shutdown can take place. Warning fields can likewise be monitored for unauthorized intrusions, but can only trigger an alarm, e.g. to slow down the vehicle. Warning fields are often arranged upstream of the protective fields so that the person causing the intrusion can, where possible, still be prevented from entering a protective field in good time.

According to a further embodiment, the 3D position data comprise a three-dimensional envelope, within which the recognized person or a representation of the recognized person is located, wherein the three-dimensional envelope is, for example, of parallelepiped shape, of cylindrical shape, of truncated cylindrical shape or of irregular shape, i.e. forms a so-called bounding box, for example. In particular, the points belonging to the person can also be directly indicated (and marked, for example). Alternatively or additionally, the 3D position data comprise a 3D position; this means that the 3D position data indicate a defined point in space at which the person or the three-dimensional envelope is located. Furthermore, the 3D position data can also recognize a pose of the recognized person. The pose can indicate a posture and/or an orientation of the recognized person. These statements apply accordingly to 3D position data for recognized objects.

According to a further embodiment, the 2D position data comprise a two-dimensional envelope, within which a representation of the recognized person is located, wherein the two-dimensional envelope is preferably rectangular, i.e. it can likewise form a (two-dimensional) bounding box. Alternatively or additionally, the 2D position data likewise comprise a position, namely a 2D position, that indicates where the person and/or the two-dimensional envelope is/are located in the 2D data. In general terms, the 3D position data and/or the 2D position data therefore comprise information that enables the determination of the position of the person in the 2D data and/or the 3D data.

The computing device is preferably configured to execute a tracking algorithm that tracks the recognized person. The tracking can preferably take place using a plurality of different input images, in particular using changing 2D data and/or 3D data. The use of the tracking algorithm can make the person recognition even more reliable since, for a person that has been recognized once, it is already approximately known in the case of changing 2D data (i.e. in the next frame) where the person is located.

According to a further embodiment, a candidate space is defined, in particular by the computing device, for the assignment of the 3D data associated with the recognized person, in which candidate space the 3D data associated with the recognized person potentially lie. In this respect, the candidate space is (at least or only) regionally bounded by the 2D position data and in particular by the two-dimensional envelope of the 2D position data. In this respect, the candidate space preferably comprises a frustum that is bounded on a side facing the sensor arrangement by the 2D position data and that extends away from the sensor arrangement.

In other words, the 2D position data therefore indicate a surface in an image of the 2D data. Preferably, all the data points that, in particular from the perspective of the sensor arrangement, correspond to this surface are disposed in the candidate space. The region behind the surface widens in three-dimensional space, viewed from the sensor arrangement, since the lines of sight of the sensor arrangement likewise widen with an increasing distance from the sensor arrangement. Therefore, as the distance from the sensor arrangement increases, the surface located between the lines of sight becomes larger so that a frustum results, i.e. a truncated pyramid shape with in particular a rectangular top surface. The top surface of the frustum preferably corresponds to the surface in the image of the 2D data, i.e. the 2D position information.

The 2D position data can also comprise an estimation of the distance from the recognized person. In this case, the 2D position data can then be arranged at a distance from the sensor arrangement in the spatial region so that the candidate space is reduced.

Ultimately, a number of data points that potentially belong to the recognized person is defined by the candidate space.

According to a further embodiment, the computing device is configured to determine the 3D data associated with the recognized person from the 3D data within the candidate space in that
a kernel density estimation takes place on the 3D data and in particular on the distance values of the 3D data;
a histogram is generated for the 3D data and in particular for the distance values of the 3D data; and/or
a mean value and/or a median value of the 3D data and in particular of the distance values of the 3D data is calculated.

A maximum of the kernel density estimation or of the histogram is preferably used as the distance value of the recognized person.

The above-mentioned possibilities for the kernel density estimation, for the histogram and for the mean and/or median value do not necessarily have to be performed on all the 3D data within the candidate space; however, only a subset of the 3D data of the candidate space can also be used. For example, the subset can be determined under the assumption that the person is very likely to be located at the center of the candidate space.

In other words, which data points belong to the person must be determined from the 3D data within the candidate space. The above-mentioned possibilities can be used for this purpose. For example, a 3D localization can therefore take place based on a kernel density estimation (KDE). In the kernel density estimation, the distance values of the 3D data can be mapped to a 1D space, wherein a distribution function is then estimated by means of a filter. The filter can, for example, be a Gaussian kernel, a “Tophat” or a linear kernel. For example, for that position at which the distribution function provides a maximum, it can then be assumed that the person is located there.

Alternatively or additionally, the aforementioned histogram can be generated for the distance values of the 3D data, wherein the maximum of the distribution can again be searched for and its depth value can be returned in order to determine the 3D position data for the recognized person. In particular, the returned depth value can be used as the distance value that indicates a distance from the center of the bounding box in the 3D position data.

When calculating the mean value and/or the median value, the determined mean value or median value is in particular directly used as the distance value for the person or the bounding box or the three-dimensional envelope.

In general, 3D data associated with the recognized person can be regarded as a cluster.

According to a further embodiment, the computing device comprises a main processor and a coprocessor, wherein the coprocessor is optimized to execute an artificial intelligence, in particular the aforementioned artificial intelligence, and at least predominantly executes the person detection method. Since the execution of the artificial intelligence usually requires a large number of matrix multiplication operations and/or accumulation floating point operations, the outsourcing to a coprocessor specifically optimized for these calculation operations is advantageous.

The coprocessor can also, in particular only, be configured for the execution of integer operations. Before the execution of calculation steps required for the artificial intelligence on the coprocessor, the input values for the calculation steps can be converted into integers, for example by quantization.

According to a further embodiment, the artificial intelligence, and in particular the neural network, which the coprocessor executes is, in particular only, configured for the processing of two-dimensional data. Due to the circumstance that the person detection method uses the 2D data, the artificial intelligence can be optimized for the processing of 2D data. An execution of machine learning operations for 3D data cannot be possible with the artificial intelligence on the coprocessor, whereby the operations for 2D data can take place particularly quickly and energy-efficiently. The coprocessor in particular cannot perform three-dimensional convolutions.

Due to the restriction to a coprocessor specialized in 2D operations, an energy consumption of the computing device can, for example, be reduced by up to 90% compared to a universal computing device.

The coprocessor can preferably be an AI accelerator chip that is coupled to the main processor via PCI Express, for example.

According to a further embodiment, the computing device is configured to perform an object recognition based on the 3D data, wherein objects are preferably recognized on the basis of a minimum size, and to output 3D data and/or 3D position data for recognized objects. In addition to the person recognition, the sensor system can therefore be configured to also recognize objects in general.

This can in particular be a different category of the recognition that, for example, takes place based on the size of an object. The object recognition preferably takes place without a prior processing of 2D data, i.e. directly on the 3D data. The recognition therefore takes place based on a simpler principle, but does not make it possible, for example, to distinguish between persons and objects. The sensor system can in particular be configured to likewise output a three-dimensional envelope and/or a three-dimensional position for the recognized objects. The sensor system can furthermore indicate whether it is a person or an object in general in each case. Such a distinction can then be used to simply drive around objects, whereas further restrictions, e.g. safety-related restrictions, can be implemented if persons are present.

According to a further embodiment, the sensor system is a self-contained unit, in particular having its own housing, in which self-contained unit or in which housing the sensor arrangement and the computing device are arranged.

Due to the efficient processing of the 2D and 3D data for the recognition of persons, it is possible to arrange the computing device and the sensor arrangement in the same housing. The software for operating the sensor system, in particular the artificial intelligence, can also be fully integrated in the sensor system. The housing can comprise a data interface with which the sensor system can, for example, be coupled to a vehicle so that the vehicle is informed of the persons and/or objects recognized by the sensor system via the data interface. Due to the configuration as a self-contained unit, the sensor system can be designed as particularly compact and can be flexibly used.

It is generally also possible to replace the person recognition method with a person and object recognition method. The person and object recognition method can be configured, in addition to persons, to also recognize predefined objects, in particular objects from the area of use of the industrial environment or of the working environment or of the spatial region in an outdoor region, e.g. pallets, mesh baskets, trailers, vehicles, signs, animals and the like. In this way, a collision e.g. with other vehicles can be avoided. The person and object recognition method can preferably only recognize a few different objects, for example, fewer than five or fewer than three different objects. A reliable recognition can thereby be ensured. The statements on the person detection method apply accordingly to the person and object recognition method. The person and object recognition method can likewise use an artificial intelligence that was trained with a large number of images of the respective objects, for example. Here, too, the statements on the person recognition method and the artificial intelligence apply accordingly.

A further subject of the invention is a vehicle, in particular a manned vehicle or an autonomous vehicle, for example an autonomous industrial truck or a lift truck or an excavator, comprising a control device for controlling the vehicle and a sensor system of the kind described herein. In this respect, the control device and the sensor system are coupled by means of a data link and the control device is configured to use 3D data and/or 3D position data, in particular of recognized persons and/or recognized objects, of the sensor system when controlling the vehicle.

The sensor system can be mounted on the vehicle such that the spatial region monitored by the sensor system corresponds to a future route of the vehicle. Alternatively or additionally, the monitored spatial region can also comprise rear or side regions of the vehicle in order to warn of persons and/or objects located there. Accordingly, the sensor system can fulfill an assistance function for a human driver of the vehicle.

A further subject of the invention is a method for monitoring a spatial region in an outdoor region or a spatial region in an industrial plant, for example for use in a manned vehicle or an autonomously driving industrial truck, wherein, in the method, 3D data of the spatial region are generated by means of a sensor arrangement, wherein 2D data of the spatial region are furthermore generated. In this respect, a person detection method, which is in particular based on artificial intelligence, is performed on the 2D data of the spatial region to recognize persons in the spatial region, wherein 2D position data are determined for a recognized person, wherein 3D data associated with the recognized person are assigned on the basis of the 2D position data for the recognized person, wherein 3D position data for the recognized person are determined from the 3D data associated with the recognized person.

The statements on the sensor system according to the invention apply accordingly to the vehicle according to the invention and the method according to the invention. This in particular applies with respect to advantages and preferred embodiments. It is furthermore understood that all the features and embodiments mentioned herein can be combined with one another, unless stated otherwise.

The invention will be described purely by way of example with reference to the drawings in the following. There are shown:

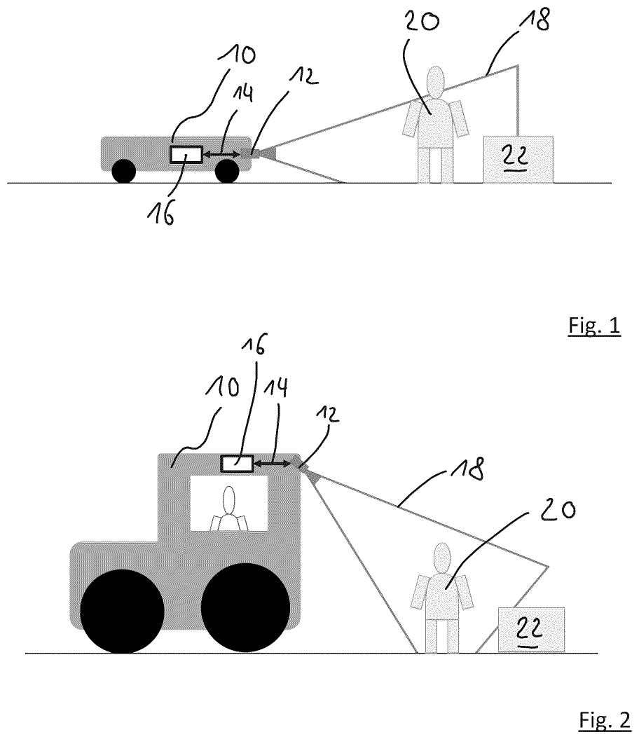

FIG. 1 an autonomous industrial truck comprising a sensor arrangement in an industrial environment;

FIG. 2 a vehicle comprising a sensor arrangement in a working environment in an outdoor region; and

FIG. 3 a recognition of a person and an object by a sensor arrangement.

FIG. 1 shows a driverless autonomously driving industrial truck 10 that is equipped with a sensor system 12. The sensor system 12 is coupled a control device 16 of the industrial truck 10 via a data link 14.

The sensor system 12 monitors a spatial region 18 in which a person 20 and an object 22, for example a pallet, are at least regionally located.

In the industrial truck 10 of FIG. 1, the sensor system 12 is attached at a relatively short distance from the floor.

Persons 20 or objects 22 recognized by the sensor system 12 can be reported to the control device 16 via the data link 14 so that the industrial truck 10 can adapt its operation to the recognized persons 20 and objects 22.

FIG. 2 shows an alternative industrial truck 10, namely a forklift truck that is used in an outdoor region and that is operated by a human operator. In the industrial truck 10 of FIG. 2, the sensor system 12 is attached significantly higher above the floor so that the monitored spatial region 18 extends towards the floor. In the industrial truck 10 of FIG. 2, the sensor system 12 is also coupled to a control device 16 via a data link 14. Persons 20 or objects 22 recognized by the sensor system 12 can be shown to the operator of the industrial truck 10 on a display (not shown), for example.

Details on the recognition of a person 20 or of objects 22 are shown in FIG. 3.

In FIG. 3, the sensor system 12 is configured as a stereo camera comprising two cameras 24 aligned in parallel with one another. The cameras 24 are coupled to a main processor 26 so that the main processor 26 receives the image data generated by the cameras 24. The image data can in particular be 2D data that are then converted into 3D data by the main processor 26. The generation of the 3D data can also take place by the cameras 24 themselves.

Both 2D data and 3D data are then available, wherein the 2D data can in particular comprise an RGB image of one of the cameras 24.

The sensor system 12 furthermore comprises a coprocessor 28, in particular in the form of an AI accelerator chip, that is coupled to the main processor 26 via a PCI Express connection 30, for example.

The main processor 26 transmits 2D data to the coprocessor 28 so that the coprocessor 28 performs a person detection method on the 2D data, said person detection method using an artificial neural network for person recognition.

The person detection method in this respect returns 2D position data 32 for the person 20. The 2D position data 32 comprise a 2D bounding box 34, which indicates a position region in the spatial region 18, and a position of the 2D bounding box 34. Based on the 2D bounding box 34, a frustum 36 is formed that includes that region which lies behind the 2D bounding box 34, viewed from the sensor system 12. The person 20 and a part of the object 22 lie in the frustum 36. These objects can be present in the 3D data as point clouds in each case. Those points in the point cloud which belong to the person 20 are identified by a kernel density estimation. Then, 3D position data for the recognized person 20 can be determined that, as a 3D bounding box 38 in the present example here, indicate the position and the approximate size of the person 20.

Since the person detection method is specifically adapted for the detection of persons 20, the object 22, which is likewise located in the spatial region 18, does not return a result of the person detection method. In particular, the main processor 26 can detect the object 22 directly based on the 3D data alone, for example based on a size recognition, and can likewise output 3D position data for the object 22 in the form of a 3D bounding box 38.

The 3D position data for the person 20 and the object 22 can then be transmitted to the control device 16 of the industrial truck 10 in order to steer the industrial truck 10 around the object 22 and, if necessary, to slow down, to stop or to warn the driver when approaching the person 20.

### REFERENCE NUMERAL LIST

10 industrial truck
12 sensor system
14 data link
16 control device
18 spatial region
20 person
22 object
24 camera
26 main processor
28 coprocessor
30 PCI Express connection
32 2D position data
34 2D bounding box
36 frustum
38 3D bounding box

1. A sensor system for monitoring a spatial region in an outdoor region or in an industrial plant, said sensor system comprising a sensor arrangement, wherein the sensor system is configured to generate 3D data of the spatial region, wherein the sensor system furthermore generates 2D data of the spatial region, wherein the sensor system has a computing device that is configured to perform a person detection method on the 2D data of the spatial region in order to recognize persons in the spatial region, wherein 2D position data are determined for a recognized person,
wherein the computing device is furthermore configured, on the basis of the 2D position data for the recognized person, to assign 3D data associated with the recognized person, wherein the computing device is further configured to determine 3D position data for the recognized person from the 3D data associated with the recognized person.

2. The sensor system according to claim 1,
wherein the computing device is configured to use only the 2D data for the person detection method for determining the 2D position data.

3. The sensor system according to claim 1,
wherein the sensor system is configured to generate the 2D data from the 3D data.

4. The sensor system according to claim 1,
wherein the person detection method comprises using an artificial intelligence.

5. The sensor system according to claim 4,
wherein the artificial intelligence has been trained with 2D data in the form of images, wherein the resolution of the images differs less than 50% or less than 30%, or less than 20%, from the resolution of the 2D data obtained by the person detection method.

6. The sensor system according to claim 1,
wherein the sensor system is configured to provide three-dimensional protective fields and/or warning fields within the spatial region, wherein a violation of a protective field and/or warning field takes place based on the 3D position data,
wherein a warning signal is output in the event of a violation of a protective field and/or warning field by a recognized person.

7. The sensor system according to claim 1,
wherein the 3D position data comprise a three-dimensional envelope, within which the recognized person is located, and/or a 3D position.

8. The sensor system according to claim 1,
wherein a candidate space is defined for the assignment of the 3D data associated with the recognized person, in which candidate space the 3D data associated with the recognized person potentially lie, wherein the candidate space is regionally bounded by the 2D position data.

9. The sensor system according to claim 8,
wherein the computing device is configured to determine the 3D data associated with the recognized person from the 3D data within the candidate space in that
a kernel density estimation takes place on the 3D data;
a histogram is generated for the 3D data; and/or . . .
a mean value and/or a median value of the 3D data is/are calculated.

10. The sensor system according to claim 1,
wherein the computing device comprises a main processor and a coprocessor, wherein the coprocessor is optimized to execute an artificial intelligence and at least predominantly executes the person detection method.

11. The sensor system according to claim 10,
wherein the artificial intelligence which the coprocessor executes is configured for the processing of two-dimensional data.

12. The sensor system according to claim 1,
wherein the computing device is configured to perform an object recognition based on the 3D data and to output 3D data and/or 3D position data for recognized objects.

13. The sensor system according to claim 1,
wherein the sensor system is a self-contained unit in which self-contained unit the sensor arrangement and the computing device are arranged.

14. A vehicle, the vehicle comprising a control device for controlling the vehicle and a sensor system, said sensor system comprising a sensor arrangement, wherein the sensor system is configured to generate 3D data of the spatial region,
wherein the sensor system furthermore generates 2D data of the spatial region,
wherein the sensor system has a computing device that is configured to perform a person detection method on the 2D data of the spatial region in order to recognize persons in the spatial region, wherein 2D position data are determined for a recognized person,
wherein the computing device is furthermore configured, on the basis of the 2D position data for the recognized person, to assign 3D data associated with the recognized person,
wherein the computing device is further configured to determine 3D position data for the recognized person from the 3D data associated with the recognized person, wherein the control device and the sensor system are coupled by means of a data link and the control device is configured to use 3D data and/or 3D position data of the sensor system when controlling the vehicle.

15. A method for monitoring a spatial region in an outdoor region or a spatial region in an industrial plant, wherein, in the method, 3D data of the spatial region are generated, wherein 2D data of the spatial region are furthermore generated, wherein a person detection method is performed on the 2D data of the spatial region to recognize persons in the spatial region, wherein 2D position data are determined for a recognized person,
wherein 3D data associated with the recognized person are assigned on the basis of the 2D position data for the recognized person,
wherein 3D position data for the recognized person are determined from the 3D data associated with the recognized person.

16. The sensor system according to claim 1,
wherein the sensor system is configured for use on a manned vehicle or an autonomously driving industrial truck.

17. The sensor system according to claim 3,
wherein the computing device is configured to generate the 2D data from the 3D data.

18. The sensor system according to claim 4,
wherein the artificial intelligence comprises an artificial neural network.

19. The sensor system according to claim 1,
wherein the 2D position data comprise a two-dimensional envelope, within which the recognized person is located, and/or a 2D position.

20. The sensor system according to claim 8,
wherein the candidate space comprises a frustum that is bounded on a side facing the sensor arrangement by the 2D position data and that extends away from the sensor arrangement.

21. The sensor system according to claim 9,
wherein a maximum of the kernel density estimation or of the histogram is used as the distance value of the recognized person.

22. The sensor system according to claim 11,
wherein the artificial intelligence which the coprocessor executes is only configured for the processing of two-dimensional data.

23. The sensor system according to claim 12,
wherein objects are recognized on the basis of a minimum size.

24. The sensor system according to claim 13,
wherein the sensor system is a self-contained unit having its own housing.

25. The vehicle according to claim 14,
wherein the vehicle is a manned vehicle, an autonomous vehicle, an autonomous industrial truck or a lift truck or an excavator.

26. The method in accordance with claim 15,
wherein the 3D data of the spatial region are generated by means of a sensor arrangement.
